(19) United States
(12) Patent Application Publication
(10) Pub. No.: US 2010/0153763 A1
(43) Pub. Date: Jun. 17, 2010

(54) Method and apparatus to modulate multi-core usage for energy efficient platform operations

(76) Inventor: Kapil Sood, Beaverton, OR (US)

Correspondence Address: INTEL CORPORATION;c/o CPA Global, P.O. BOX 52050, MINNEAPOLIS, MN, 55402, US

(21) Appl. No.: 12/316,329

(22) Filed: Dec. 11, 2008

(51) Int. Cl. G06F 1/32

(52) U.S. Cl. 713/324

(57) ABSTRACT

An energy efficient multi-core computing device and method are disclosed. According to embodiments of the invention, the processing load on a multi-core computing device may be monitored to determine whether one or more cores on the device may be dynamically shut down. Conversely, any core that is shut down may be dynamically powered up if the processing load on the device increases. Embodiments of the present invention therefore provide significant energy savings on multi-core platforms by minimizing the active cores on the device without affecting the device's processing capabilities.

### BACKGROUND

In recent years, environmental issues such as energy conservation have been the focus of various discussions and debates. While there are disagreements on the methods used to conserve energy and the effects of various solutions on the environment, there is an overwhelming agreement that everyone should attempt to contribute to these goals. In light of this, corporations and individuals alike have implemented various environmentally friendly and energy saving measures such as hybrid vehicles and recyclable products.

### BRIEF DESCRIPTION OF THE DRAWINGS

The present invention is illustrated by way of example and not limitation in the figures of the accompanying drawings in which like references indicate similar elements, and in which:

FIG. 1a illustrates a typical multi-core platform;

FIG. 1b illustrates a typical virtualized multi-core platform;

FIG. 2 illustrates an embodiment of the present invention;

FIG. 3 is a control flow chart illustrating an embodiment of the present invention; and

FIG. 4 is a flow chart illustrating an embodiment of the present invention

### DETAILED DESCRIPTION

One side effect of the increase in computer use in society is the increase in energy consumption related to the use and maintenance of these devices. In addition to the widespread use of computing devices, technological advances have also contributed to increased energy use. For example, devices with multiple central processing units (CPUs) or multiple “cores” (hereafter “multi-core”) require more energy when powered up than devices with a single core, regardless of whether all the cores on the device are being utilized. Additionally, low traffic patterns on a multi-core device may also result in wasted energy because all the cores on the device utilize a set amount of energy, regardless of the level of activity. Thus, for example, even if the level of activity is such that it could be easily serviced by a single core, all the cores on the device continue to utilize energy while idle.

As used in this specification, the phrases “one embodiment” or “an embodiment” of the present invention means that a particular feature, structure or characteristic described in connection with the embodiment is included in at least one embodiment of the present invention. Thus, the appearances of the phrases “in one embodiment,” “according to one embodiment” or the like appearing in various places throughout the specification are not necessarily all referring to the same embodiment. Additionally, reference in the specification to the term “device” may include any one of a number of processor based computing devices, including but not limited to desktop computing devices, portable computing devices (laptops as well as handhelds), set-top boxes, and game consoles. Handheld devices may include, but are not limited to, personal digital assistants (PDAs), mobile internet devices (MIDs), laptops, digital cameras, media players, ultra mobile personal computers (UMPCs) and/or any computing device that is capable of roaming on, and connecting to, a network.

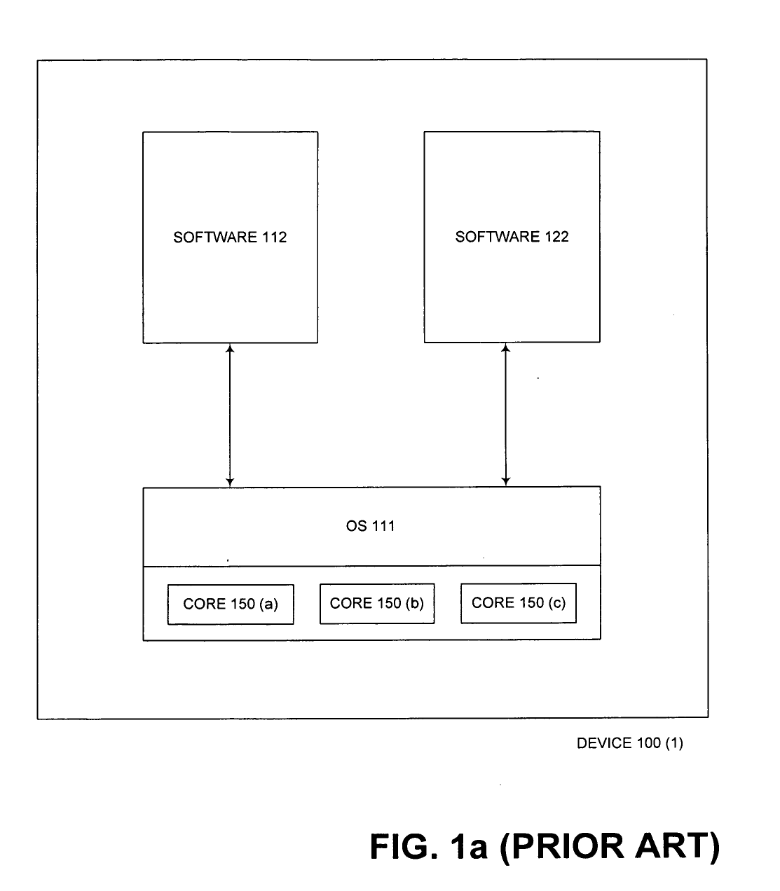

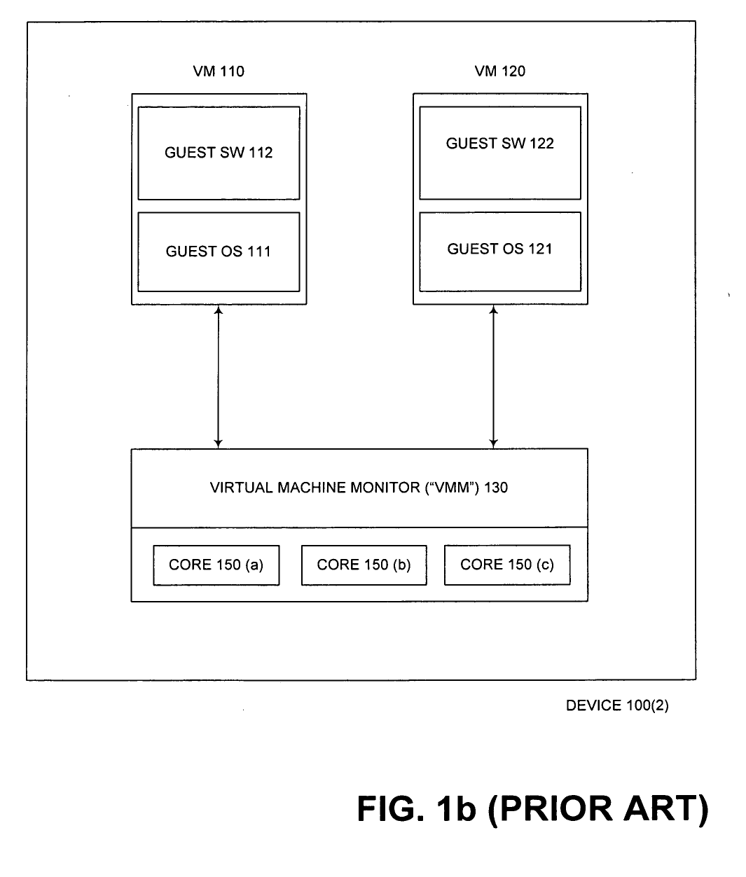

Computing devices typically include an operating system (OS 111) hosted directly on the device core(s) (illustrated as Cores 150(a), 150(b) and 150(c), as illustrated by the exemplary device (Device 100(1)) in FIG. 1a. For clarity, only some components are illustrated in Device 100(1) but it will be readily apparent to one of ordinary skill in the art that various other components may co-exist with the shown elements. Application software (Software 112 and Software 122) may execute on OS 111, which allocates the resources of CPUs 150(a-c) according to a typical operating system scheme.

Alternatively, the computing devices may be virtualized as illustrated by the exemplary device (Device 100(2)) in FIG. 1b, running a Virtual Machine Manager (VMM 130) or hypervisor that enables Host 100(2) to run one or more virtual machines (VM 110 and VM 120 here). Again, for clarity, only some components are illustrated in Device 100(2) but it will be readily apparent to one of ordinary skill in the art that various other components may co-exist with the shown elements. Each VM may include application software (Guest SW 112 and Guest SW 122) executing on an operating system (Guest OS 111 and Guest OS 121) and VMM 130 may manage the resources on the host (e.g., allocating Cores 150(a-c) to various processes on VM 110 and VM 120. Regardless of the environment, computing devices typically experience varying traffic patterns, ranging from busy to no traffic. Even the busiest data centers, and typical home computers, for example, experience significant off-peak hours that see very low traffic patterns and OS or VMM loads.

Embodiments of the present invention enable an energy efficient multi-core computing device. More specifically, according to embodiments of the invention, application and/or network traffic load on a multi-core computing device may be monitored to determine whether one or more cores on the device may be dynamically shut down. Conversely, any core that is shut down may be dynamically powered up if the processing load on the device increases. Embodiments of the present invention therefore provide significant energy savings on multi-core platforms by minimizing the active cores on the device without affecting the device's processing capabilities. 100131 According to one embodiment, an energy management module (“EMM”) may manage the various cores on the platform, modulating the availability of the cores based on network traffic. The following description assumes the use of an Intel multi-core computing device that includes an embedded processor such as Active Management Technologies/Manageability Engine (“AMT/ME”), but embodiments of the invention are not so limited. Instead, other embodiments may be implemented on any multi-core computing device that includes the same or similar functionality as an Intel AMT/ME computing platform. In one embodiment, the EMM may monitor the network and OS loads on the platform and turn on and off individual cores with a power-regulator switch.

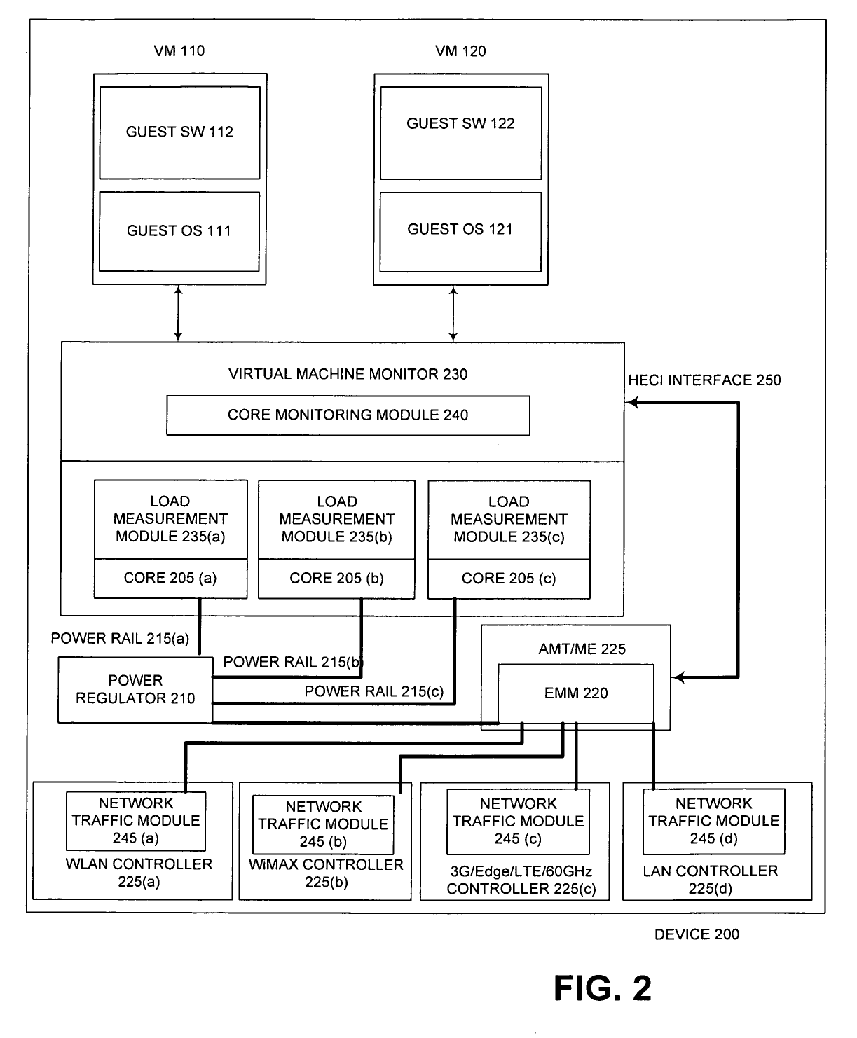

FIG. 2 illustrates an embodiment of the invention. As illustrated, Device 200 may include a multiple cores Core 205(a), 205(b) and 205(c) (collectively “Cores 205”). For clarity, only 3 cores are illustrated in this embodiment but other embodiments of the invention may include devices with more or less cores. In an embodiment, each core may run independent and/or different operating system, and each core may be coupled to Power Regulator 210 via an independent power rail, illustrated as Power Rail 215(a), Power Rail 215(b) and Power Rail 215(c) (collectively “Power Rails 215”). The independent Power Rails 215 enable each of Cores 205 to be independently turned on and off. Thus, unlike currently available multi-core devices (illustrated in FIG. 1) in which a single power rail typically couples all cores to a power regulator, embodiments of the present invention may regulate power to individual cores via the independent power rails.

In various embodiments, EMM 220 may reside within AMT/ME 225 (as illustrated) or simply be coupled to AMT/ME 225. Additionally, as illustrated, AMT/ME 220 may be coupled to WLAN Controller 225(a), WiMAX Controller 225(b), 3G/Edge/LTE/60 GHz Controller 225(c), and LAN Controller 225(d) (collectively “Controllers 225”), to monitor LAN, WLAN, 3G/LTE/60 GHz and WiMAX traffic patterns and loads. AMT/ME 220 may also be coupled to Power Regulator 210. In one embodiment illustrated herein, Device 200 is a virtualized device, while alternate embodiments may be implemented on a non-virtualized platform. Virtualized Device 200 may include a virtual machine manager VMM 230, which is also coupled to AMT/ME 220.

On both virtualized and non-virtualized platforms, EMM 220 may continually monitor the load, energy consumption and other attributes of Cores 205. In one embodiment, EMM 220 may reside within AMT/ME 225 and be configured according to a predetermined policy that defines when to trigger a power off or power on of each of the cores. More specifically, according to an embodiment, upon receipt of a triggering message or signal from EMM 220, Power Regulator 210 may utilize the appropriate independent power rail to shut down a core. Thus, for example, if the message from EMM 220 is that Core 205(b) is being minimally utilized and should be powered off, Power Regulator 210 may, via Power Rail 215(b) shut down Core 205(b) without affecting the functionality of the other cores. Similarly, EMM 220 may send a message to Power Regulator 210 to power on a core, when deemed necessary according to the predetermined policy.

In one embodiment of the invention, an example policy may comprise actions based on various measurements including: (i) a threshold for each traffic rate and traffic type from each of Controllers 225; (ii) a single threshold for cumulative traffic ingress from all the platform Controllers 225; and/or (iii) a threshold comprising a combination of the network traffic rate on the platform and the OS/application CPU usage rate. In order for EMM 220 to utilize the policy, in one embodiment, each core on the platform may include or be coupled to a module that collects active statistics about various aspects of that core, including CPU power, load and timing information. The module on each core (Load Measurement Module 235(a)-(c), hereafter collectively “Load Measurement Module 235”) may transmit the statistics to EMM 220. In an alternate embodiment, EMM 220 may poll Load Measurement Module 235 for the statistics.

According to one embodiment a Core Monitoring Module (hereafter “Core Monitoring Module 240”) may be coupled to VMM 230, to ensure that if a core is powered off, no OS or application on the platform will be impacted. In other words, if Core Monitoring Module 240 determines that an OS or application is directly accessing a specific core that EMM 220 determines may be powered off to conserve energy, Core Monitoring Module 240 may de-couple the OS and/or application from that core prior to the core being shutdown. In one embodiment, Core Monitoring Module 240 may reschedule the OS and/or application to a different core on Device 200. Core Monitoring Module 240 thus ensures that power off and power on events are completely transparent to the OS and applications running on Device 200. Although Core Monitoring Module 240 is illustrated in FIG. 2 as residing within VMM 230, embodiments of the invention are not so limited and Core Monitoring Module 240 may simply be coupled to VMM 230 in alternate embodiments.

In one embodiment, a network traffic module (“Network Traffic Module 245(a-d)”, collectively Network Traffic Module 245) may collect network traffic information from each of Controllers 225. Specifically, in one embodiment, Network Traffic Module 245 may measure the rate and type of ingress and egress traffic on Device 200 and may periodically report its collected statistics to EMM 220. In an alternate embodiment, EMM 220 may poll Network Traffic Module 245 for the network statistics. Communications between Controllers 225 and EMM 220 may occur via clink interfaces and support independent out of band communication links between the network controllers and AMT 230. Additionally, in one embodiment, a Host Embedded Controller Interface, hereafter “HECI” 250 may provide a communication channel between the components running on the AMT (e.g., EMM220 and Core Manager 235) and the software components running on the cores (e.g., VMM 230).

In one embodiment, Load Measurement Module 230, Core Monitoring Module 240 and/or Network Traffic Module 245 may provide dynamic data to EMM 220 pertaining to the activity on Device 200. This dynamic update enables EMM 220 to determine whether energy efficiencies may be achieved by turning off one or more cores. Traffic Measure Component 245 may comprise any form of traffic monitoring currently implemented in Controllers 225(a-d) or other proprietary mechanisms without departing from the spirit of embodiments of the present invention.

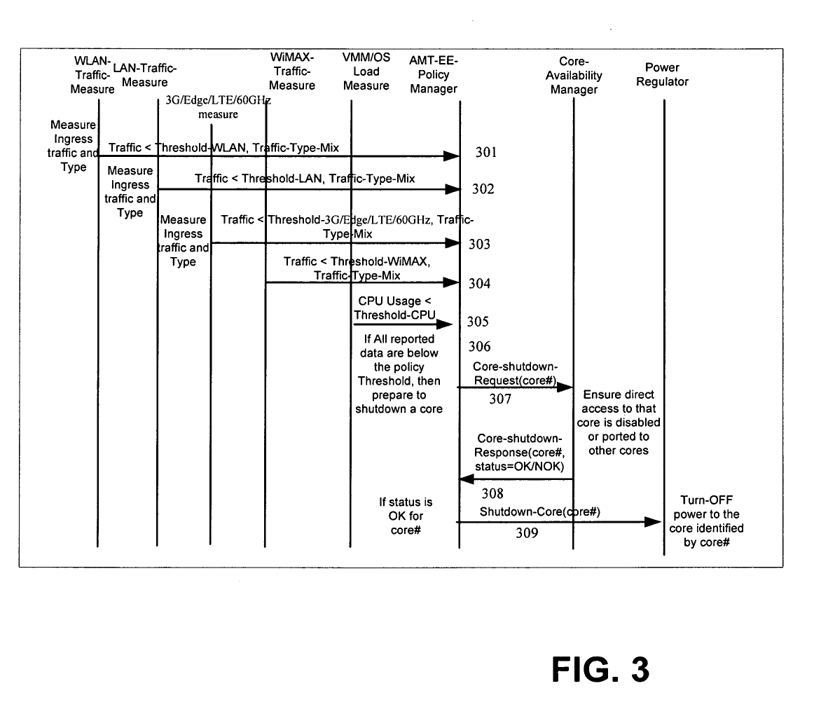

FIG. 3 is a control flow diagram illustrating the steps according to an embodiment of the present invention. As illustrated, in 301, 302, 303 and 304, Controllers 125(a-d) may each report the incoming traffic rate and traffic type to EMM 220. Additionally, in 305, VMM 230 and/or the OS on the device may report the CPU usage to EMM 120. EMM 220 may in 306 execute a predefined policy checking algorithm against the reported data from each controller and the VMM/OS. In particular, EMM 220 may evaluate the existing data as well as extrapolate from the existing data to determine future ingress and egress traffic. Thus, for example, EMM 220 may evaluate CPU utilization according to the following assumptions:

a. If incoming traffic includes a web query (e.g., a web page access or a simple page rendering), the impact on CPU usage may be low;

b. If incoming traffic is a database query, the impact on CPU usage may be high;

c. If incoming traffic is a Secure Session Layer/Transport Layer Security (SSL/TLS) session, the impact on CPU usage may be medium.

The above scenarios are merely exemplary and embodiments of the invention are not so limited. Instead, the predetermined policy may include fewer or additional assumptions or rules. Based on the predetermined policy, in 307, EMM 220 may consult Core Monitoring Module 240 to ensure that the core designated to be powered off is not running critical portion of the OS and/or an application (e.g., a native thread from any OS or application). Upon receiving confirmation in 308, EMM 220 may shutdown the core in 309. In one embodiment, if Core Monitoring Module 240 determines that the core is running an important thread, VMM 230 may reschedule the thread to a different core. In an alternate embodiment, VMM 230 may respond to EMM 220 that the core cannot be shutdown.

According to one embodiment of the invention, if the core is not running any threads and/or the threads have been rescheduled to run on a different core, EMM 220 may send a signal to Power Regulator 210 via the appropriate power rail, to shut down the specific core. Thus, for example, if the core to be shutdown is Core 205(b), EMM 220 may send a signal to Power Regulator 210 via Power Rail 215(b). Power Regulator 210 may thereafter shut down Core 205(b).

In one embodiment of the invention, EMM 220 may reverse the above process to turn on the power to a core. To ensure platform performance, EMM 220 may in one embodiment always ensure that the platform computing capabilities at all time exceed the OS and/or applications requirements. In alternate embodiments, EMM 220 may specify different thresholds in the predetermined policy.

According to embodiments of the present invention, the device may dynamically regulate its power utilization based on ongoing and anticipated loads on the device. One embodiment may accomplish this without any dependency on the OS, applications and/or network load balancers and instead relies on EMM 220 to make the dynamic adjustments based on criteria specified by the user, corporation or other entity. Furthermore, in one embodiment, the user experience is untouched because the OS and applications on the platform continue to execute seamlessly. Thus, although the underlying cores may be turned on and off based on load or usage, the user may be completely oblivious to this activity. To the user, the platform may continue executing, appearing to be always running and available.

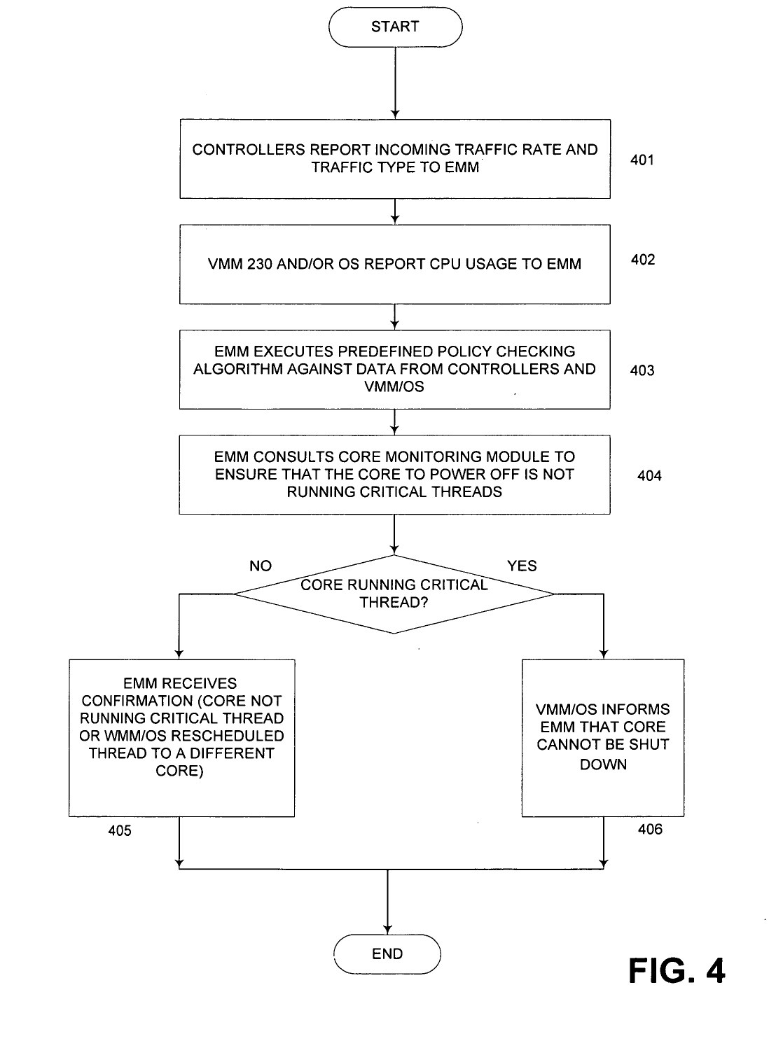

FIG. 4 is a flow chart illustrating one embodiment of the present invention. Although the following operations may be described as a sequential process, many of the operations may in fact be performed in parallel and/or concurrently. In addition, one or more embodiments, the order of the operations may be re-arranged without departing from the spirit of embodiments of the invention. In 401, Controllers 225(a-d) may each report the incoming traffic rate and traffic type to EMM 220. In 402 VMM 230 and/or the OS on the device may report the CPU usage to EMM 220 EMM 220 may in 403 execute a predefined policy checking algorithm against the reported data from each controller and the VMM/OS. In 404, based on the predetermined policy, EMM 220 may consult Core Monitoring Module 240 to ensure that the core designated to be powered off is not running critical portion of the OS and/or an application (e.g., a native thread from any OS or application). Upon receiving confirmation in 405 that the core is either (i) not running a critical thread or (ii) the VMM/OS has rescheduled one or more critical threads from the core to a different core, EMM 220 may shutdown the core. Alternatively, in 406, if Core Monitoring Module 240 informs VMM230 that the core is running an important thread, VMM 230 may respond to EMM 220 that the core cannot be shutdown.

The scheme according to embodiments of the present invention may be implemented on a variety of computing devices. According to an embodiment, a computing device may include various other well-known components such as one or more processors which can be specialized Reduced Instruction Set Computer (RISC) engines or general purpose processing engines. The processor(s) and machine-accessible media may be communicatively coupled using a bridge/memory controller, and the processor may be capable of executing instructions stored in the machine-accessible media. The bridge/memory controller may be coupled to a graphics controller, and the graphics controller may control the output of display data on a display device. The bridge/memory controller may be coupled to one or more buses. One or more of these elements may be integrated together with the processor on a single package or using multiple packages or dies. A host bus controller such as a Universal Serial Bus (“USB”) host controller may be coupled to the bus(es) and a plurality of devices may be coupled to the USB. For example, user input devices such as a keyboard and mouse may be included in the computing device for providing input data. In alternate embodiments, the host bus controller may be compatible with various other interconnect standards including Ethernet, Gigabit Ethernet, PCI, PCI Express, FireWire and other such existing and future standards.

In the foregoing specification, the invention has been described with reference to specific exemplary embodiments thereof. It will, however, be appreciated that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method, comprising:
determining load information on a device having a plurality of processing cores;
comparing the load information against a predetermined policy; and
performing one of shutting down and turning on one of the plurality of processing cores based on the comparison.

2. The method according to claim 1 further comprising:
shutting down the one of the plurality of processing cores if the load is below the threshold specified in the predetermined policy; and
starting up the one of the plurality of processing cores if the load is above the threshold specified in the predetermined policy

3. The method according to claim 2 wherein determining the load information further comprises one or more of the following:
determining current and extrapolated operating system processing requirements;
determining current and extrapolated application processing requirements; and
determining current and extrapolated network traffic requirements.

4. The method according to claim 3 wherein shutting down the at least one of the plurality of processing cores further comprises:
determining whether at least one of a current operating system task, a current application task and a current networking task are running on the at least one of the plurality of processing cores; and
if at least one of the tasks is running on the at least one of the plurality of processing cores, rescheduling the at least one of the tasks to another one of the plurality of processing cores prior to shutting down the at least one of the plurality of processing cores.

5. The method according to claim 2 further comprising:
determining the current operating system and application processing requirements from an operating system on the device; and
determining the current network processing requirements from a network traffic module on the device.

6. The method according to claim 1 wherein the device is virtualized and includes a virtual machine monitor.

7. The method according to claim 1 wherein the device includes an embedded processor running an energy monitoring module, the embedded processor capable of accessing and comparing the load information against the predetermined policy.

8. A system, comprising:
a load measurement module capable of determining load information on a device having a plurality of processing cores;
an energy management module capable of comparing the load information against a predetermined policy, the energy management module further capable of performing one of shutting down and turning on one of the plurality of processing cores based on the comparison.

9. The system according to claim 8 wherein the energy efficient module if further capable of:
shutting down the one of the plurality of processing cores if the load is below the threshold specified in the predetermined policy; and
starting up the one of the plurality of processing cores if the load is above the threshold specified in the predetermined policy

10. The system according to claim 9 further comprising:
a operating system monitoring module capable of determining current and extrapolated operating system processing requirements and providing the current and extrapolated operating system processing requirements to the energy efficient module;
a core monitoring module capable of determining current and extrapolated application processing requirements and providing the current and extrapolated application processing requirements to the energy efficient module; and
a network traffic module capable of determining current and extrapolated network traffic requirements and providing the current and extrapolated network traffic requirements to the energy efficient module.

11. The system according to claim 10 wherein if one of a current operating system task, a current application task and a current networking task are running on the at least one of the plurality of processing cores, the energy efficient module is further capable of rescheduling the at least one of the tasks to another one of the plurality of processing cores prior to shutting down the at least one of the plurality of processing cores.

12. The system according to claim 8 wherein the operating system monitoring module is a virtual machine monitor.

13. The system according to claim 8 further comprising:
an embedded processor running the energy monitoring module.

14. A machine accessible medium having stored thereon instructions that, when executed by a machine, cause the machine to:
determine load information on a device having a plurality of processing cores;
compare the load information against a predetermined policy; and
perform one of shutting down and turning on one of the plurality of processing cores based on the comparison.

15. The machine accessible medium according to claim 14 wherein the instructions, when executed by the machine, cause the machine to:
shut down the one of the plurality of processing cores if the load is below the threshold specified in the predetermined policy; and
start up the one of the plurality of processing cores if the load is above the threshold specified in the predetermined policy

16. The machine accessible according to claim 15 wherein the instructions, when executed by the machine, cause the machine to determine the load information by:
determining current and extrapolated operating system processing requirements;
determining current and extrapolated application processing requirements; and
determining current and extrapolated network traffic requirements.

17. The machine accessible according to claim 16 wherein the instructions, when executed by the machine, cause the machine to shut down the at least one of the plurality of processing cores by:
determining whether at least one of a current operating system task, a current application task and a current networking task are running on the at least one of the plurality of processing cores; and
if at least one of the tasks is running on the at least one of the plurality of processing cores, rescheduling the at least one of the tasks to another one of the plurality of processing cores prior to shutting down the at least one of the plurality of processing cores.

18. The machine accessible according to claim 14 wherein the instructions, when executed by the machine, further cause the machine to:
determine the current operating system and application processing requirements from an operating system on the device; and
determine the current network processing requirements from a network traffic module on the device.

19. The machine accessible according to claim 13 wherein the device is virtualized and wherein the instructions, when executed by the machine, cause the machine to execute a virtual machine monitor.

20. The machine accessible according to claim 13 wherein the device includes an embedded processor running an energy monitoring module, and wherein the instructions, when executed by the machine, cause the embedded processor to access and compare the load information against the predetermined policy.
